(19) United States
(12) Patent Application Publication
(10) Pub. No.: US 2022/0147902 A1
(43) Pub. Date: May 12, 2022

(54) PLATOON TRAVEL MANAGEMENT APPARATUS, PLATOON TRAVEL MANAGEMENT METHOD, AND COMPUTER-READABLE RECORDING MEDIUM HAVING PROGRAM RECORDED THEREIN

(71) Applicant: NEC Corporation, Minato-ku, Tokyo (JP)

(72) Inventor: Kazuki INAGAKI, Tokyo (JP)

(73) Assignee: NEC Corporation, Minato-ku, Tokyo (JP)

(21) Appl. No.: 17/438,550

(22) PCT Filed: Mar. 19, 2020
(86) PCT No.: PCT/JP2020/012399

§ 371 Date: Sep. 13, 2021

(30) Foreign Application Priority Data
Mar. 26, 2019 (JP) 2019-057962

(51) Int. Cl. G06Q 10/06; G06Q 50/30; G08G 1/00; G05D 1/02

(52) U.S. Cl. CPC G06Q 10/063112; G06Q 50/30; G05D 2201/0213; G05D 1/0293; G08G 1/22

(57) ABSTRACT

A platoon travel management apparatus selects a driver for driving a vehicle in platoon travel in which multiple vehicles travel in a line forming a platoon from among requesting drivers who have requested to drive vehicles in the platoon travel on the basis of a schedule for the platoon travel, attributes of the requesting drivers, and driving schedules of the requesting drivers.

### TECHNICAL FIELD

The present invention relates to a platoon travel management apparatus, a platoon travel management method, and a computer-readable recording medium having a program recorded therein.

### BACKGROUND ART

In recent years, technologies for making vehicles travel by forming platoons have been considered. By making vehicles travel by forming platoons, advantageous effects such as improved fuel economy of the vehicles and increased transportable quantities can be expected. Platoon travel is likely to be often implemented in predetermined intervals, for example, on expressways and the like. In such cases, it is contemplated that the grouping of platoons for platoon travel would be performed in dedicated spaces or the like provided in service areas on expressways and the like.

Patent Document 1 discloses technology for enabling grouped travel in which multiple vehicles travel in a group. Additionally, Patent Document 1 describes that a travel management center receives reservation requests including vehicles to participate in grouped travel, the departure points and destination points of those vehicles, and preferred times, registers the received reservation requests, proposes travel plans, and monitors the grouped travel implementation conditions.

### PRIOR ART DOCUMENT

### Patent Document

Patent Document 1: Japanese Unexamined Patent Application, First Publication No. 2017-62691

### SUMMARY

### Problems to be Solved by the Invention

In the platoon travel mentioned above, it is contemplated that the vehicles of multiple businesses managing the vehicles would form platoons to implement platoon travel. Driving vehicles to perform platoon travel in this way requires securing drivers who are suited to driving in platoon travel, and thus technology for efficiently securing platoon travel vehicle drivers is needed.

Thus, an example object of the present invention is to provide a platoon travel management apparatus, a platoon travel management method, and a computer-readable recording medium having a program recorded therein, which solve the above-mentioned problem.

### Means for Solving the Problems

According to a first example aspect of the invention, a platoon travel management apparatus includes driver selection means that select a driver for driving a vehicle in platoon travel in which multiple vehicles travel in a line forming a platoon from among requesting drivers who have requested to drive vehicles in the platoon travel on the basis of a schedule for the platoon travel, attributes of the requesting drivers, and driving schedules of the requesting drivers.

According to a second example aspect of the invention, a platoon travel management method includes: selecting a driver for driving a vehicle in platoon travel in which multiple vehicles travel in a line forming a platoon from among requesting drivers who have requested to drive vehicles in the platoon travel on the basis of a schedule for the platoon travel, attributes of the requesting drivers, and driving schedules of the requesting drivers.

According to a third example aspect of the invention, a computer-readable recording medium records a program for making a computer in a platoon travel management apparatus function as: driver selection means that select a driver for driving a vehicle in platoon travel in which multiple vehicles travel in a line forming a platoon from among requesting drivers who have requested to drive vehicles in the platoon travel on the basis of a schedule for the platoon travel, attributes of the requesting drivers, and driving schedules of the requesting drivers.

### Example Advantageous Effects of Invention

According to the present invention, platoon travel vehicle drivers can be efficiently secured.

### BRIEF DESCRIPTION OF THE DRAWINGS

FIG. 1 is a diagram illustrating the configuration of a platoon travel management system according to an example embodiment of the present invention.

FIG. 2 is a hardware configuration diagram of a platoon travel management apparatus according to an example embodiment of the present invention.

FIG. 3 is a functional block diagram of a platoon travel management apparatus according to an example embodiment of the present invention.

FIG. 4 is a flow chart illustrating the processing in a platoon travel management apparatus according to an example embodiment of the present invention.

FIG. 5 is a diagram illustrating the contents of driver request information according to an example embodiment of the present invention.

FIG. 6 is a diagram illustrating the contents of platoon travel request information according to an example embodiment of the present invention.

FIG. 7 is a diagram illustrating an example of a screen showing a webpage for registering driver request information according to an example embodiment of the present invention.

FIG. 8 is a diagram illustrating an example of a screen showing a webpage for registering platoon travel request information according to an example embodiment of the present invention.

FIG. 9 is a diagram illustrating the minimum configuration of a platoon travel management apparatus according to an example embodiment of the present invention.

FIG. 10 is a flow chart illustrating processing corresponding to the minimum configuration of a platoon travel management apparatus according to an example embodiment of the present invention.

### EXAMPLE EMBODIMENT

Hereinafter, a platoon travel management apparatus according to an example embodiment of the present invention and a platoon travel management system provided with the platoon travel management apparatus will be explained with reference to the drawings.

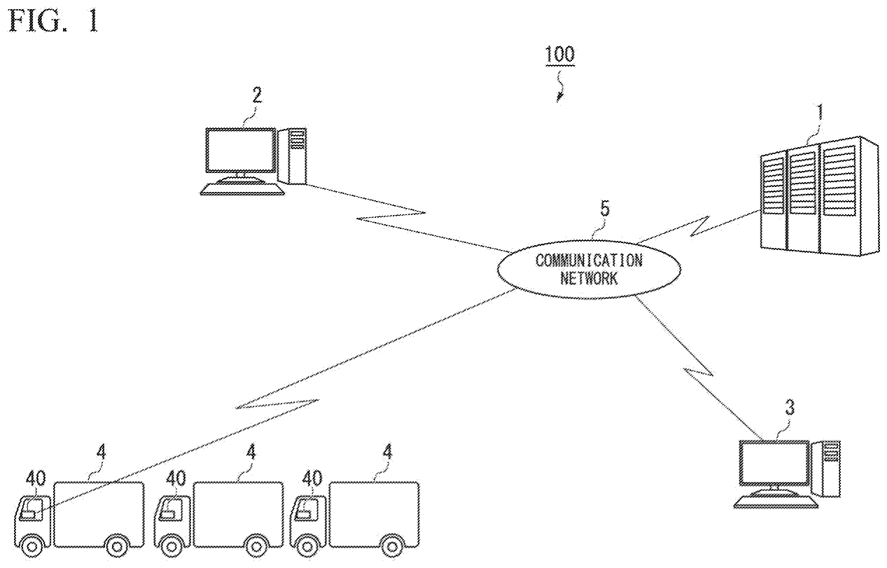

FIG. 1 is a diagram illustrating the configuration of a platoon travel management system provided with the platoon travel management apparatus according to the present example embodiment.

As illustrated in FIG. 1, the platoon travel management system 100, in one example, is configured to include a platoon travel management apparatus 1, onboard devices 40 mounted on vehicles 4, a driver terminal 2, and a vehicle manager terminal 3. The platoon travel management apparatus 1, the onboard devices 40, the driver terminal 2 and the vehicle manager terminal 3 are connected via a communication network 5. The driver terminal 2, which is a terminal used by a driver driving a vehicle in platoon travel, connects to the platoon travel management apparatus 1 and communicates with the platoon travel management apparatus 1. Additionally, the vehicle manager terminal 3, which is a terminal used by a manager who manages vehicles in the platoon travel, connects to the platoon travel management apparatus 1 and communicates with the platoon travel management apparatus 1. The driver terminal 2 and the vehicle manager terminal 3 may be a personal computer or a mobile terminal used by the driver or the manager.

In the present example embodiment, the onboard device 40 is assumed to have functions for implementing platoon travel. For example, in the case that the vehicle on which the onboard device 40 is mounted is a vehicle other than the leading vehicle in the platoon travel, in order to travel while following a vehicle (a vehicle ahead) 4 participating in the platoon travel at a position directly in front of that vehicle, the onboard device 40 may be provided with a function for detecting the distance to and the position of the vehicle ahead, a function for controlling the transmission and reception of radar for performing said detection, a function for controlling the speed and the advancement direction of the vehicle based on the detection results, a function for connecting with an onboard device 40 provided in another vehicle in the platoon travel and communicating with that onboard device 40, and the like. The onboard device 40 may have a function for performing processes for implementing platoon travel on the basis of information received from the platoon travel management apparatus 1. As the processes performed by the onboard device 40 for implementing platoon travel, known technology is used.

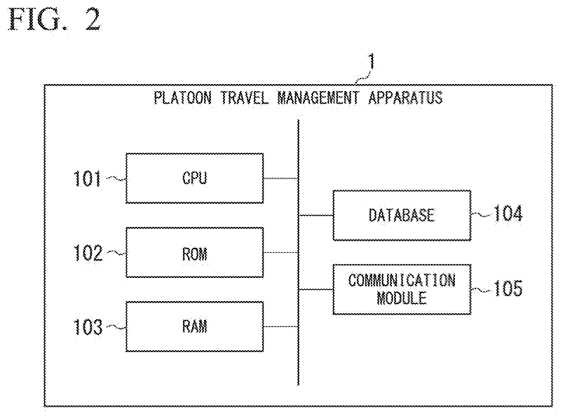

FIG. 2 is a hardware configuration diagram of the platoon travel management apparatus 1.

As illustrated in this diagram, the platoon travel management apparatus 1 is a computer provided with hardware such as a central processing unit (CPU) 101, a read-only memory (ROM) 102, a random access memory (RAM) 103, a storage device for storing a database 104, and a communication module 105.

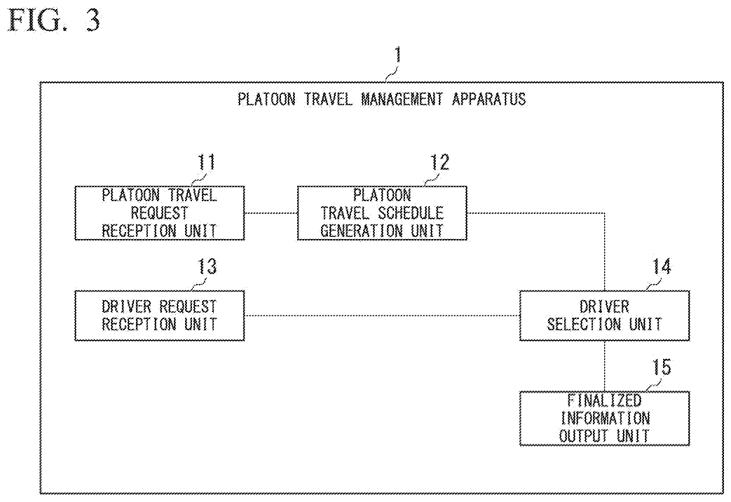

FIG. 3 is a functional block diagram of the platoon travel management apparatus 1.

The platoon travel management apparatus 1 starts up when the power is turned on, and executes a pre-stored platoon travel management program. As a result thereof, the platoon travel management apparatus 1 activates the functions of a platoon travel request reception unit (platoon travel request reception means) 11, a platoon travel schedule generation unit (platoon travel schedule generation means) 12, a driver request reception unit (driver request reception means) 13, a driver selection unit (driver selection means) 14, and a finalized information output unit 15.

The platoon travel request reception unit 11 receives, from the vehicle manager terminal 3, platoon travel request information including individual travel schedules indicating the individual travel schedules of the respective vehicles. The platoon travel request reception unit 11 has the function of a web server. The platoon travel request reception unit 11 transmits a corresponding webpage for requesting platoon travel to the vehicle manager terminal 3 on the basis of access from the vehicle manager terminal 3 to a platoon travel request Uniform Resource Locator (URL).

The platoon travel schedule generation unit 12 acquires the individual travel schedule of each of the multiple vehicles, and identifies combinations of vehicles for forming platoon travel on the basis of the individual travel schedules. Additionally, the platoon travel schedule generation unit 12 generates a schedule for the platoon travel on the basis of the individual travel schedules for the vehicles forming that platoon travel.

The driver request reception unit 13 receives, from the driver terminal 2, request information (driver request information) from a requesting driver, including at least the attributes of the requesting driver and the driving schedule of the requesting driver. The driver request reception unit 13 also has the function of a web server. The driver request reception unit 13 transmits a corresponding webpage for requesting to be a driver to the driver terminal 2 on the basis of access from the driver terminal 2 to a driver request URL.

The driver selection unit 14 selects a driver for driving a vehicle in platoon travel from among the requesting drivers on the basis of the platoon travel schedule, the attributes of the requesting drivers, and the driving schedules of the requesting drivers.

The finalized information output unit 15 outputs, to a predetermined output destination, finalized schedule information, which includes the platoon travel schedule and the ID (identifier, identification information) of a driver who is to drive a vehicle included in the platoon travel. The predetermined output destination may be a driver terminal 2, a vehicle manager terminal 3, or an onboard device 40.

In the platoon travel management apparatus 1 as mentioned above, a driver for driving a vehicle in the platoon travel indicated by the platoon travel schedule is selected from among the multiple requesting drivers on the basis of the platoon travel schedule, the attributes of requesting drivers, and the driving schedules of the requesting drivers. Thus, a driver of a vehicle in the platoon travel can be efficiently secured. As one example, the selected driver drives the leading vehicle in the platoon travel. The onboard devices 40 mounted on the vehicles following the leading vehicle in the platoon travel implement control to maintain the platoon travel by controlling the vehicles, by automated driving, to maintain the inter-vehicular distance with respect the vehicle traveling immediately ahead.

It should be noted that when a platoon travel schedule has been prepared, as one example, multiple vehicles 4 form a platoon in a predetermined dedicated area provided in an expressway service area or the like. For example, each of the multiple vehicles 4 enter the expressway from different entrances and arrive at the dedicated area (departure point) in a predetermined service area.

In the dedicated area, the drivers of the vehicles 4 drive the vehicles 4 with which the drivers themselves are charged and move the vehicles 4 to positions in the platoon (positions in a predetermined order in the platoon) for the vehicles to implement platoon travel specified by the platoon travel request information. The drivers operate the onboard devices 40 provided in the vehicles 4 and instruct them to start processes for implementing the platoon travel. At this time, the onboard devices 40 may use the finalized schedule information explained below to implement platoon travel starting control under control by the platoon travel management apparatus 1.

Then, one driver identified by the driver selection process in the processing in steps S101 to S111 below enters the vehicle 4 positioned to lead the platoon and drives the vehicle manually or automatically, and the trailing vehicles 4 travel by maintaining the distance to the vehicle 4 positioned immediately ahead in said platoon. It should be noted that among the drivers who have driven vehicles 4 to the departure point of the platoon travel, the drivers not driving a vehicle in the platoon travel leave the departure point by using predetermined transportation means.

The trailing vehicles 4 other than the vehicle 4 leading the platoon travel may or may not be manned by drivers. If the trailing vehicles 4 other than the lead vehicle 4 are not manned by drivers, then other drivers that can take over the drivers for the unmanned vehicles in the platoon travel should be waiting in a dedicated area that is a destination point at which the platoon is to be disbanded, indicating the endpoint of the interval over which the platoon travel is to be implemented. The vehicles 4 constituting platoon travel may exit an expressway from different exits and travel to different final destinations.

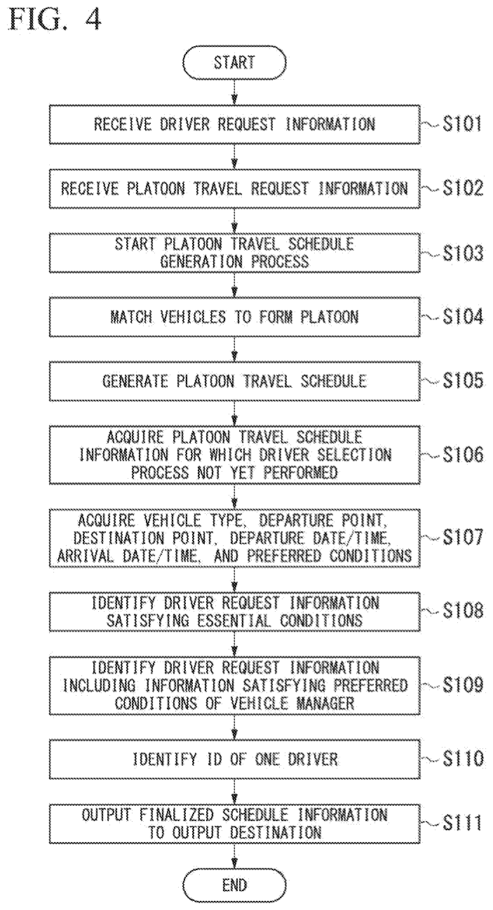

FIG. 4 is a flow chart illustrating the processing in the platoon travel management apparatus 1.

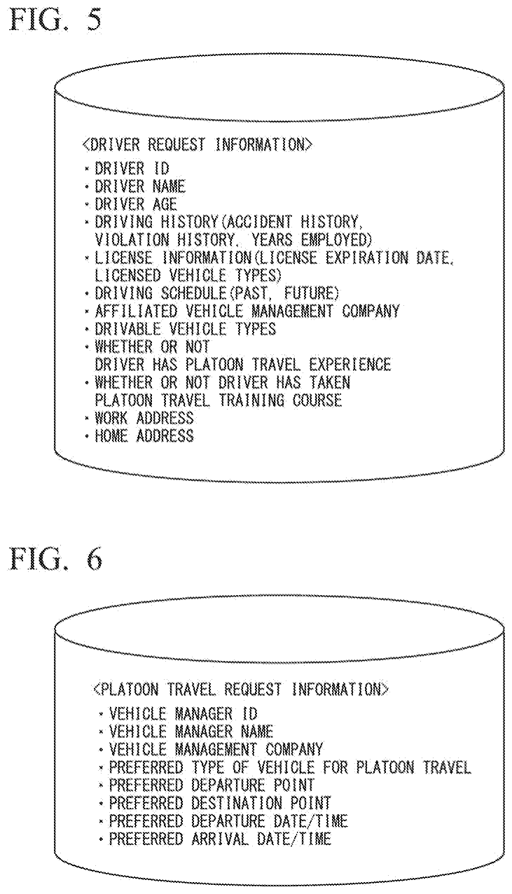

FIG. 5 is a diagram illustrating the contents of driver request information.

FIG. 6 is a diagram illustrating the contents of platoon travel request information.

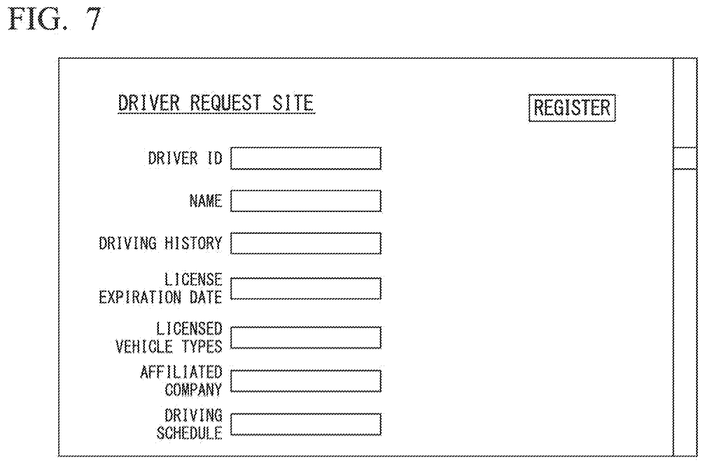

FIG. 7 is a diagram illustrating an example of a screen showing a webpage for registering driver request information.

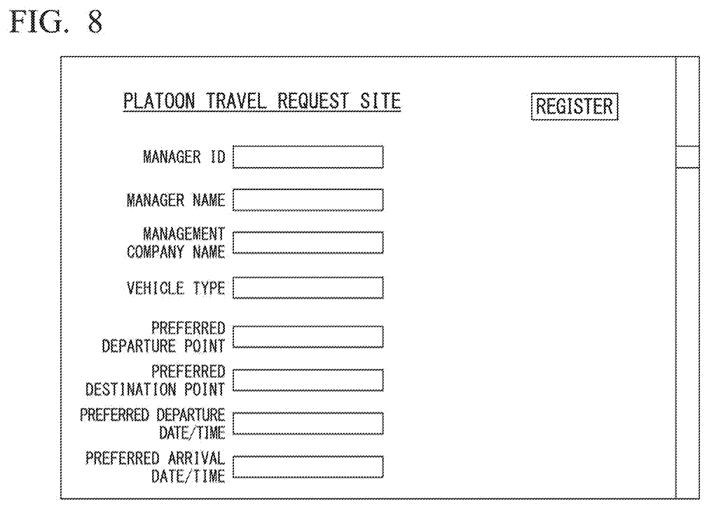

FIG. 8 is a diagram illustrating an example of a screen showing a webpage for registering platoon travel request information.

First, a driver who is to request to drive in platoon travel uses the driver terminal 2 to access the driver request URL. Then, the driver request reception unit 13 in the platoon travel management apparatus 1 transmits, to the driver terminal 2, a webpage (FIG. 7) for requesting to be a driver. The driver terminal 2 outputs, to a monitor (not illustrated), the webpage for requesting to be a driver. The webpage for requesting to be a driver includes input fields for at least inputting attributes and a driving schedule of a driver. The driver enters the necessary information in the input fields on the webpage output to the monitor of the driver terminal 2, and provides an instruction to transmit the information. Then, the driver terminal 2 transmits, to the platoon travel management apparatus 1, driver request information including the information that the driver entered in the input fields on said webpage. The driver request reception unit 13 in the platoon travel management apparatus 1 receives the driver request information (step S101). The driver request reception unit 13 records the driver request information in the database 104 in the platoon travel management apparatus 1.

As illustrated in FIG. 5, the driver request information includes information such as the ID of the driver who is the operator of the driver terminal 2 that transmitted the driver request information, the driver's name, the driver's age, the driver's driving history (accident history, violation history, years employed), license information (license expiration date, licensed vehicle types), the driving schedule (past driving schedule, future planned driving schedule), the vehicle management company (such as a logistics company) with which the driver is affiliated (employed), the drivable vehicle types, whether or not the driver has platoon travel experience, whether or not the driver has taken a platoon travel training course, a work address, and a home address.

Meanwhile, a vehicle manager who manages a vehicle to perform platoon travel uses the vehicle manager terminal 3 to access the platoon travel request URL. Then, the platoon travel request reception unit 11 in the platoon travel management apparatus 1 transmits, to the vehicle manager terminal 3, a webpage (FIG. 8) for requesting platoon travel. The vehicle manager terminal 3 outputs, to a monitor (not illustrated), the webpage for requesting platoon travel. The webpage for requesting platoon travel includes input fields for at least inputting attributes of the vehicle to perform platoon travel and the individual travel schedule of that vehicle. The vehicle manager enters the necessary information in the input fields on the webpage output to the monitor of the vehicle manager terminal 3, and provides an instruction to transmit the information. Then, the vehicle manager terminal 3 transmits, to the platoon travel management apparatus 1, platoon travel request information including the information that the vehicle manager entered in the input fields on said webpage. The platoon travel request reception unit 11 in the platoon travel management apparatus 1 receives the platoon travel request information (step S102). The platoon travel request reception unit 11 records the platoon travel request information in the database 104 in the platoon travel management apparatus 1.

As illustrated in FIG. 6, the platoon travel request information includes information such as the ID of the vehicle manager who is the operator of the vehicle manager terminal 3 that transmitted the platoon travel request information, the vehicle manager's name, the vehicle management company to which the vehicle belongs, the preferred vehicle type of the vehicle for platoon travel, the preferred departure point, the preferred destination point, the preferred departure date/time, and the preferred arrival date/time. The preferred departure point and the preferred destination point are the departure point and the destination point of the platoon travel preferred by the vehicle manager. Additionally, the preferred departure date/time and the preferred arrival date/time are a date and time at which the vehicle is to be present at the preferred departure point and the preferred destination point. The vehicle manager is able to select one or more preferred departure points and preferred destination points on the webpage for requesting platoon travel.

The driver request reception unit 13 receives driver request information from driver terminals 2 operated by many drivers. Additionally, the platoon travel request reception unit 11 receives platoon travel request information from vehicle manager terminals 3 operated by many vehicle managers. Thus, the database 104 stores many sets of driver request information and platoon travel request information.

Then, the platoon travel schedule generation unit 12 in the platoon travel management apparatus 1 starts a platoon travel schedule generation process at predetermined time intervals or at a predefined timing (step S103). The platoon travel schedule generation unit 12 extracts platoon travel request information designating unprocessed vehicles among the vehicles seeking to participate in platoon travel designated by the many sets of platoon travel request information recorded in the database 104, and matches vehicles to form a platoon on the basis of those sets of platoon travel request information (step S104). Specifically, the platoon travel schedule generation unit 12 extracts, from among the platoon travel request information designating unprocessed vehicles, platoon travel request information having the same preferred departure point and preferred destination point, having the same days as the preferred departure date and the preferred arrival date, and for which the difference between the preferred departure times and the difference between the preferred arrival times are both within a predetermined time, as platoon travel request information designating vehicles that are candidates to be included in the same platoon. The platoon travel schedule generation unit 12 determines vehicles to be included in the same platoon from among these candidates on the basis of the number of vehicles that can be candidates to be included in the same platoon indicated by the extracted platoon travel request information.

For example, the platoon travel management apparatus 1 pre-stores an upper limit value of the number of vehicles that can be included in the same platoon. If the number of vehicles that are candidates to be included in the same platoon is equal to or less than the upper limit value, then the platoon travel schedule generation unit 12 determines those candidate vehicles as vehicles to be included in the same platoon. Alternatively, if the number of vehicles that are candidates to be included in the same platoon exceeds the upper limit value, then the platoon travel schedule generation unit 12 determines a number of vehicles equal to the upper limit value, in the order of request time, from among the candidate vehicles, and determines these vehicles as the final vehicles to be included in the same platoon.

The platoon travel schedule generation unit 12 generates a platoon travel schedule including at least the vehicle IDs of the final vehicles determined to be included in the same platoon, the vehicle types of the vehicles, the departure point, the destination point, the departure date/time, and the arrival date/time (step S105). At this time, as one example, the platoon travel schedule generation unit 12 computes, as the departure date/time and the arrival date/time, the averages of the dates/times of the preferred departure dates/times and the preferred arrival dates/times in the platoon travel request information corresponding to the final vehicles. The platoon travel schedule generation unit 12 records the platoon travel schedule information in the database 104. As a result thereof, the platoon travel schedule information is collected in the database 104. The platoon travel schedule generation unit 12 records, in the database 104, the platoon travel request information corresponding to the vehicle IDs included in the platoon travel schedule, in association with flags indicating that the information has been processed,

The platoon travel schedule generation unit 12 may generate information indicating preferred conditions regarding a driver for driving a vehicle in the platoon specified by the generated platoon travel schedule information, and information indicating the preferred conditions may be included in the platoon travel schedule information. For example, the platoon travel schedule generation unit 12 acquires information such as the IDs of vehicle management companies included in the platoon travel request information used to generate the platoon travel schedule. The platoon travel management apparatus 1 stores preferred conditions regarding drivers in association with the IDs of vehicle management companies. These preferred conditions may include, for example, a lower limit on the number of years in the driving history (years employed) of a driver who is to drive in platoon travel, a flag indicating whether or not platoon travel experience is necessary, or the like. The preferred conditions may further include a flag indicating whether or not the driver must be affiliated with a vehicle management company, a flag indicating whether or not the driving history must be free of accidents and violations, or the like.

The driver selection unit 14 acquires, from among the platoon travel schedule information stored in the database 104, platoon travel schedule information for which the driver selection process has not yet been performed (step S106). The driver selection unit 14 acquires, from the platoon travel schedule, information regarding the vehicle type, the departure point, the destination point, the departure date/time, the arrival date/time, and the preferred conditions (step S107). The preferred conditions are assumed to include a lower limit on the number of years in the driving history (years employed) of a driver who is to drive in the platoon travel, and a flag indicating whether or not platoon travel experience is necessary. The driver selection unit 14 first identifies, from the driver request information stored in the database 104, driver request information satisfying essential conditions (step S108). For example, as driver request information satisfying the essential conditions, the driver selection unit 14 identifies, from the driver request information stored in the database 104, driver request information including a work address or a home address close to the departure point, not including the departure date/time in the future planned driving schedule, not having an expired license, and including a type of vehicle that is to form the platoon as a licensed vehicle type.

Additionally, the driver selection unit 14 further identifies, from the identified driver request information, driver request information including information satisfying the preferred conditions of the vehicle manager (step S109). In other words, the driver selection unit 14 identifies driver request information in which the driving history (years employed) included in the driver request information is at least the lower limit number of years in the driving history (years employed) included in the preferred conditions, and in which the information regarding whether or not the driver has platoon travel experience included in the driver request information indicates that the driver has platoon travel experience. If there is a single set of driver request information that is finally identified, then the driver selection unit 14 identifies the driver ID included in that driver request information, and if there are multiple sets of driver request information that are finally identified, then the ID of one driver is randomly identified from among the drivers indicated by the driver IDs included in those sets of driver request information (step S110). As a result thereof, the driver selection unit 14 selects a driver. If a driver ID cannot be identified, then the driver selection unit 14 may perform the driver selection process by excluding one of the items of information among the information included in the preferred conditions.

It should be noted that the driver selection unit 14 may further perform a determination as to whether or not the driver can arrive at the departure point by the departure date/time on the basis of the driver request information identified in step S108, and if this determination indicates that the driver can arrive at the departure point by the departure date/time, then the ID of that driver may be identified. In this case, the driver selection unit 14 computes the time difference between the last scheduled time (driving plans), in the future schedule of the driver, before the departure date/time indicated by the schedule for the platoon travel being currently processed, and the time indicated by the departure date/time. If the time difference is equal to or greater than a predetermined time, such as one hour, then the driver selection unit 14 determines that the driver can arrive at the departure point by the departure date/time. The driver selection unit 14 may identify the last scheduled time (driving plans) and arrival point, in the future schedule of the driver, before the departure date/time indicated by the schedule for the platoon travel being currently processed, and may determine that the driver can arrive at the departure point by the departure date/time if a time obtained by adding, to that last time, the required travel time from that arrival point to the departure point is equal to or greater than a predetermined time, such as 30 minutes, before the departure date/time indicated by the schedule for the platoon travel being processed. In order to compute the required travel time, known point-to-point travel time processes may be used.

Additionally, the driver selection unit 14 may determine whether the working time (schedule) per predetermined time period, such as per month or per day, will become equal to or greater than a predetermined time on the basis of the driver request information identified in step S108, and may identify the ID of a driver when the working time can be determined as not being equal to or greater than the predetermined time. In this case, the driver selection unit 14 calculates the finalized driving times of the past or future driving schedules within the predetermined time period, and computes the total driving time by adding, to the finalized driving times, the time from the departure date/time to the arrival date/time indicated by the platoon travel schedule being newly processed. If this total driving time is less than an upper limit of the working time in the predetermined time period, then the driver selection unit 14 determines that the working time will not be equal to or greater than the predetermined time.

Additionally, the driver selection unit 14 determines, on the basis of the driver request information identified in step S108, whether a rest time indicated by the time difference between the departure date/time of the platoon travel schedule currently being processed and the arrival date/time in the driving schedule arranged before the platoon travel schedule being processed in the past or future driving schedule of the identified driver is equal to or greater than a predetermined time. Furthermore, if the rest time is equal to or greater than the predetermined time, then the driver selection unit may identify the ID of that driver.

When identifying the ID of one driver from among the multiple drivers in the processing in step S110, the driver selection unit 14 may identify the ID of the one driver using priority conditions. Specifically, the driver selection unit 14 may compute the driving times from a time point that is a predetermined time period in the past up to the present on the basis of the past driving schedule, and may identify the ID of the driver with the least driving time.

Additionally, when identifying the ID of one driver from among the multiple drivers in the processing in step S110, the driver selection unit 14 may identify the work addresses or the home addresses of the drivers on the basis of the driver request information. Then, the driver selection unit 14 may compute the distances between the work addresses or home addresses of the drivers and the departure point or the destination point by using known point-to-point distance computation techniques, and may identify the ID of the driver for whom the distance is the shortest.

Additionally, when identifying the ID of one driver from among the multiple drivers in the processing in step S110, the driver selection unit 14 identifies the vehicle management companies with which the drivers are affiliated on the basis of the driver request information, and identifies the vehicle management companies of the vehicles on the basis of the information in the platoon travel schedule. Then, the driver selection unit 14 may compare the vehicle management companies and may identify the ID of a driver affiliated with a vehicle management company of a vehicle included in the platoon.

Additionally, when identifying the ID of one driver from among the multiple drivers in the processing in step S110, the driver selection unit 14 may acquire the number of accidents in accident histories or the number of violations in violation histories, and identify the ID of the driver with the lowest number.

The driver selection unit 14 may use a driver selection model generated by machine learning in the past, may identify one or more sets of driver request information including information satisfying the preferred conditions of the vehicle manager, and may identify the driver request information including the ID of one driver from among the identified driver request information on the basis of the above-mentioned process. The machine learning process for generating the driver selection model may be performed by the platoon travel management apparatus 1 or by another apparatus. As one example, a model generation unit (not illustrated) in the platoon travel management apparatus 1 generates the driver selection model. The model generation unit implements machine learning on the basis of the correspondence between platoon travel request information and multiple sets of driver request information stored in the database 104, which were processed when selecting drivers who have already been registered in the past, and a single set of driver request information identifying the ID of the driver from among those sets of driver request information. Then, the model generation unit generates a driver selection model identifying one or more sets of driver request information by using, as input information, the platoon travel request information and the multiple sets of driver request information stored in the database 104. Known technology can be used as the machine learning technique.

When the ID of one driver is identified, the driver selection unit 14 outputs, to the finalized information output unit 15, finalized schedule information in which the ID of the identified driver is included in the platoon travel schedule acquired for processing in step S106. The finalized information output unit 15 outputs the finalized schedule information to output destinations such as the driver terminal 2 corresponding to the driver ID included in the finalized schedule information, the vehicle manager terminal 3 corresponding to the vehicle manager ID, the onboard devices 40 corresponding to the vehicle IDs, or the monitor or the database 104 connected to the platoon travel management apparatus 1 (step S111).

The processes performed by the platoon travel management apparatus have been explained above. According to the above-mentioned processes, vehicles to form a platoon are matched on the basis of platoon travel request information and driver request information, and a driver to drive in that platoon is automatically matched. As a result thereof, a driver of a vehicle in the platoon travel can be efficiently secured.

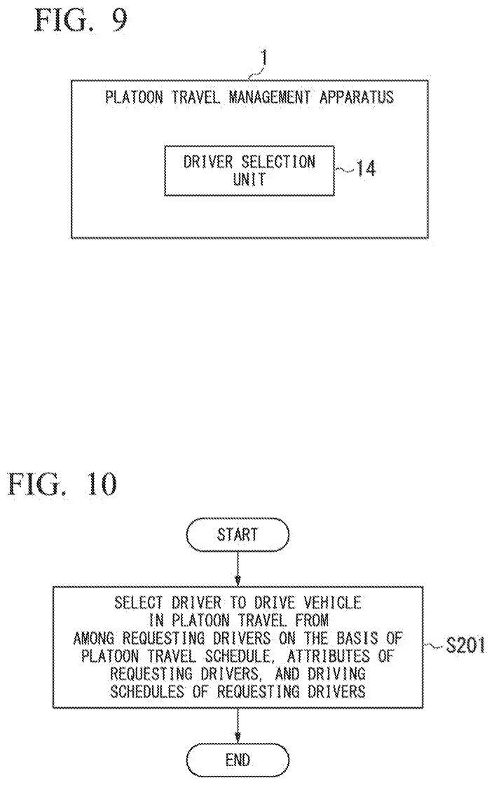

FIG. 9 is a diagram illustrating the minimum configuration of the platoon travel management apparatus.

FIG. 10 is a flow chart illustrating processing corresponding to the minimum configuration of the platoon travel management apparatus.

The platoon travel management apparatus 1 is provided with at least a driver selection unit 14.

The driver selection unit 14 selects a driver for driving a vehicle in platoon travel, in which multiple vehicles travel in a line forming a platoon, from among requesting drivers, who have requested to drive a vehicle in the platoon travel, on the basis of a schedule for the platoon travel, attributes of the requesting drivers, and driving schedules of the requesting drivers (step S201).

Each of the above-mentioned apparatuses have a computer system contained therein. Furthermore, the steps in the above-mentioned processes are stored in a computer-readable recording medium in the form of a program, and the above-mentioned processes are performed by a computer reading out and executing this program. In this case, the computer-readable recording medium refers to a magnetic disc, a magneto-optic disc, a compact disc (CD)-ROM, a digital versatile disc (DVD)-ROM, a semiconductor memory, or the like. Additionally, this computer program may be distributed to a computer by means of a communication line, and the computer that has received this distribution may execute the program.

Additionally, the above-mentioned program may be for realizing a portion of the aforementioned functions. Furthermore, the above-mentioned program may be in the form of a so-called difference file (difference program) that can realize the aforementioned functions by being combined with a program that is already recorded in a computer system.

Although the present invention has been explained above by referring to example embodiments thereof, the present invention is not limited to the above-mentioned example embodiments. The configuration and details of the present invention may be modified, within the scope of the present invention, in various ways that could be understood by a person skilled in the art.

This application is based upon and claims the benefit of priority from Japanese Patent Application No. 2019-057962, filed Mar. 26, 2019, the disclosure of which is incorporated herein in its entirety by reference.

### INDUSTRIAL APPLICABILITY

The present invention is applicable, for example, to platoon travel in which multiple vehicles travel in a line forming the platoon. According to the present invention, a driver of a vehicle in the platoon travel can be efficiently secured.

### DESCRIPTION OF REFERENCE SIGNS

1 Platoon travel management apparatus
2 Driver terminal
3 Vehicle manager terminal
4 Vehicle
11 Platoon travel request reception unit
12 Platoon travel schedule generation unit
13 Driver request reception unit
14 Driver selection unit
15 Finalized information output unit
40 Onboard device

What is claimed is:

1. A platoon travel management apparatus comprising:
at least one memory configured to store instructions; and
at least one processor configured to execute the instructions to:
select a driver for driving a vehicle in platoon travel in which multiple vehicles travel in a line forming a platoon from among requesting drivers who have requested to drive vehicles in the platoon travel on the basis of a schedule for the platoon travel, attributes of the requesting drivers, and driving schedules of the requesting drivers.

2. The platoon travel management apparatus according to claim 1, wherein the attributes of the requesting drivers indicate at least identification information, a name, a license expiration date, a licensed vehicle type, and whether or not a platoon travel training course has been taken, regarding the requesting drivers.

3. The platoon travel management apparatus according to claim 1,
wherein the at least one processor is configured to execute the instructions to: acquire individual travel schedules for the multiple vehicles, identify combinations of vehicles for forming the platoon travel on the basis of the individual travel schedules, and generate the schedule for the platoon travel on the basis of the individual travel schedules of the identified vehicles.

4. The platoon travel management apparatus according to claim 3,
wherein the at least one processor is configured to execute the instructions to: receive the individual travel schedules from a vehicle manager terminal used by a manager managing the vehicles.

5. The platoon travel management apparatus according to claim 1,
wherein the at least one processor is configured to execute the instructions to: receive, from driver terminals used by the requesting drivers, request information of the requesting drivers that includes at least the attributes of the requesting drivers and the driving schedules of the requesting drivers.

6. A platoon travel management method comprising:
selecting a driver for driving a vehicle in platoon travel in which multiple vehicles travel in a line forming a platoon from among requesting drivers who have requested to drive vehicles in the platoon travel on the basis of a schedule for the platoon travel, attributes of the requesting drivers, and driving schedules of the requesting drivers.

7. The platoon travel management method according to claim 6, comprising:
acquiring individual travel schedules for the multiple vehicles, identifying combinations of vehicles for forming the platoon travel on the basis of the individual travel schedules, and generating the schedule for the platoon travel on the basis of the individual travel schedules of the identified vehicles.

8. The platoon travel management method according to claim 7, comprising:
receiving the individual travel schedules from a vehicle manager terminal used by a manager managing the vehicles.

9. The platoon travel management method according to claim 6, comprising:
receiving, from driver terminals used by the requesting drivers, request information of the requesting drivers that includes at least the attributes of the requesting drivers and the driving schedules of the requesting drivers.

10. A non-transitory computer-readable recording medium recording a program for making a computer in a platoon travel management apparatus function to:
select a driver for driving a vehicle in platoon travel in which multiple vehicles travel in a line forming a platoon from among requesting drivers who have requested to drive vehicles in the platoon travel on the basis of a schedule for the platoon travel, attributes of the requesting drivers, and driving schedules of the requesting drivers.
